(19) United States
(12) Patent Application Publication
(10) Pub. No.: US 2025/0361899 A1
(43) Pub. Date: Nov. 27, 2025

(54) TWIST-LOCK FASTENERS, ASSEMBLIES, AND METHODS FOR FASTENING

(71) Applicant: The Boeing Company, Arlington, VA (US)

(72) Inventors: Lon E. Switzer, Marysville, WA (US); Nolan A. Wall, Marysville, WA (US); David L. Wilson, Marysville, WA (US); Boe C. Stanton, Stanwood, WA (US)

(73) Assignee: The Boeing Company, Arlington, VA (US)

(21) Appl. No.: 19/061,154

(22) Filed: Feb. 24, 2025

Related U.S. Application Data
(60) Provisional application No. 63/651,468, filed on May 24, 2024.

(51) Int. Cl. F16B 21/04; F16B 2/26

(52) U.S. Cl. CPC F16B 21/04; F16B 2/26; F16B 5/10; F16B 7/20

(57) ABSTRACT

A twist-lock fastener includes an anchor and a retainer. The anchor is configured for attaching to a first article. The anchor includes a body forming a cavity. The retainer includes a locking portion and a holding portion. The locking portion is configured for inserting in the cavity and selectively locking to the body. The holding portion extends from the locking portion and is configured for holding a second article.

### PRIORITY

This application claims priority from U.S. Ser. No. 63/651,468 filed on May 24, 2024, the entire contents of which are incorporated herein by reference.

### FIELD

The present disclosure relates generally to fastening systems and, more particularly, to twist-lock fastener systems configured to securely fasten two articles together, assemblies including two articles fastened together using twist-lock fasteners, and methods for fastening two articles together using twist-lock fasteners.

### BACKGROUND

Fasteners are an important part of any assembly operation. Conventional fastener systems designed for attachment to a surface of an article often require the use of adhesives, multi-layer backings, threaded inserts, or full penetration through the article to hold the fastener securely in place. While these methods fulfill their intended purpose, they typically result in physical alteration of the article to which the fastener is attached or otherwise detract from the aesthetic appeal of the article. Accordingly, those skilled in the art continue with research and development efforts in fastening systems.

### SUMMARY

Disclosed are examples of a twist-lock fastener, an assembly, and a method for fastening. The following is a non-exhaustive list of examples, which may or may not be claimed, of the subject matter according to the present disclosure.

In an example, the disclosed twist-lock fastener includes an anchor and a retainer. The anchor is configured for attaching to a first article. The anchor includes a body forming a cavity. The retainer includes a locking portion and a holding portion. The locking portion is configured for inserting in the cavity and selectively locking to the body. The holding portion extends from the locking portion and is configured for holding a second article.

In another example, the disclosed twist-lock fastener includes an anchor and a retainer. The anchor is configured for attaching to a first article. The anchor includes a body having a semi-cylindrical shape. The body includes a first longitudinal end and a second longitudinal end opposite the first longitudinal end to form a cavity having a cylindrical shape. The body includes a first arc end and a second arc end spaced away from the first arc end to form an opening in the body. The anchor includes a first slot formed in the body proximate the first longitudinal end. The body includes a second slot formed in the body proximate the first longitudinal end and opposite the first slot. The anchor includes a first anchor tab extending outwardly from the body proximate the first arc end. The anchor includes a second anchor tab extending outwardly from the body proximate the second arc end. The anchor includes a lip extending outwardly from the body opposite the opening. The anchor includes first teeth extending from the first anchor tab. The anchor includes second teeth extending from the second anchor tab. The anchor includes a receiver extending inwardly from the body opposite the opening. The retainer is configured for mating with the anchor in a first angular orientation and engaging the anchor in a second angular orientation. The retainer includes a locking portion configured for inserting in the cavity and selectively locking to the body. The locking portion includes a base configured for inserting in the opening in the first angular orientation and engaging the body in the second angular orientation. The locking portion includes a first retainer flange extending outwardly from the base and configured for mating with the first slot. The locking portion includes a second retainer flange extending outwardly from the base opposite the first retainer flange and configured for mating with the second slot. The locking portion includes a pin extending from the base and configured for inserting in the aperture of the receiver. The retainer includes a holding portion extending from the locking portion and configured for holding a second article. With the locking portion of the retainer inserted in the cavity of the body of the anchor, the retainer is configured for rotating relative to the anchor between an unlocked position and a locked position.

In an example, the disclosed assembly includes a first article and a second article coupled to the first article by the twist-lock fastener.

In another example, the disclosed assembly includes a first article including a hole. The assembly includes an anchor. The anchor is situated in the hole and is coupled to the first article. The anchor includes a body forming a cavity. The assembly includes a retainer. The retainer includes a locking portion inserted in the cavity and selectively locked to the body. The retainer includes a holding portion extending from the locking portion. The assembly includes a second article coupled to the first article by the holding portion.

In an example, the disclosed method is for fastening a first article and a second article together using the twist-lock fastener.

In another example, the disclosed method includes steps of: (1) coupling an anchor of a twist-lock fastener to a first article; (2) coupling a retainer of the twist-lock fastener and the anchor by: (2a) in a first angular orientation, mating the retainer with the anchor 110; (2b) rotating the retainer relative to the anchor from the first angular orientation to a second angular orientation; and (2c) in the second angular orientation, engaging the retainer to the anchor; and (3) coupling a second article to the first article using the retainer.

Other examples of the twist-lock fastener, the assembly, and the method will become apparent from the following detailed description, the accompanying drawings, and the appended claims.

### BRIEF DESCRIPTION OF THE DRAWINGS

FIG. 1 is a schematic block diagram of an assembly;

FIG. 2 is a flow diagram of an example of a fastening method;

FIG. 3 is a schematic, perspective view of an example of a twist-lock fastener in a first condition;

FIG. 4 is a schematic, perspective view of an example of a twist-lock fastener in a second condition;

FIG. 5 is a schematic, perspective view of an example of a twist-lock fastener in a third condition;

FIG. 6 is a schematic, perspective view of an example of a retainer of the twist-lock fastener;

FIG. 7 is a schematic, opposing perspective view of the example of the retainer shown in FIG. 6;

FIG. 8 is a schematic, sectional view of an example of the retainer;

FIG. 9 is a schematic, perspective view of an example of an anchor of the twist-lock fastener;

FIG. 10 is a schematic, perspective view of an example of the assembly;

FIG. 11 is a schematic, sectional view of an example of the assembly;

FIG. 12 is a schematic, sectional view of an example of the assembly;

FIG. 13 is a flow diagram of an example of an aircraft manufacturing and service method; and

FIG. 14 is a schematic block diagram of an example of an aircraft.

### DETAILED DESCRIPTION

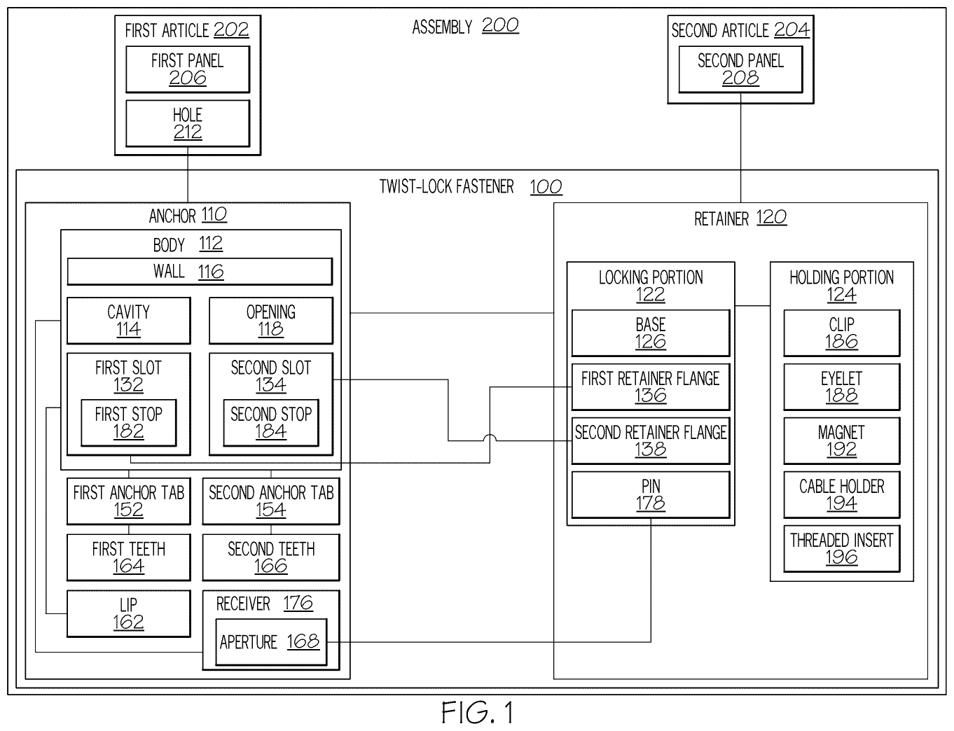

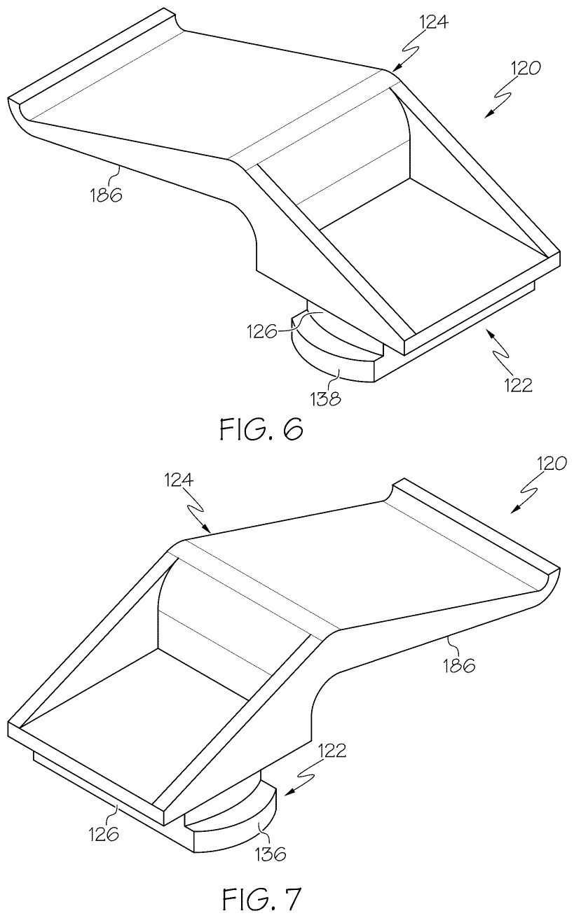

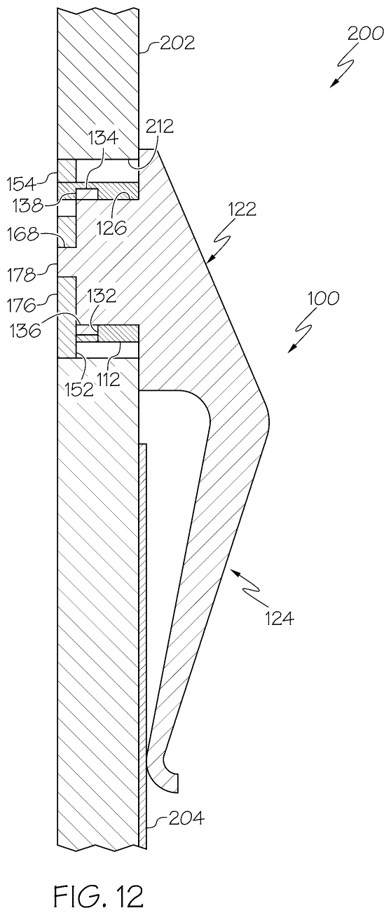

Referring generally to FIGS. 1-12, by way of examples, the present disclosure is directed to a twist-lock fastener 100, an assembly 200, and a method 1000 for fastening components of the assembly 200 using the twist-lock fastener 100. Examples of the twist-lock fastener 100 and method 1000 provide a means by which a fastener can be attached from one side of an article, such as a panel, without utilizing adhesives or full penetration to hold it securely in place.

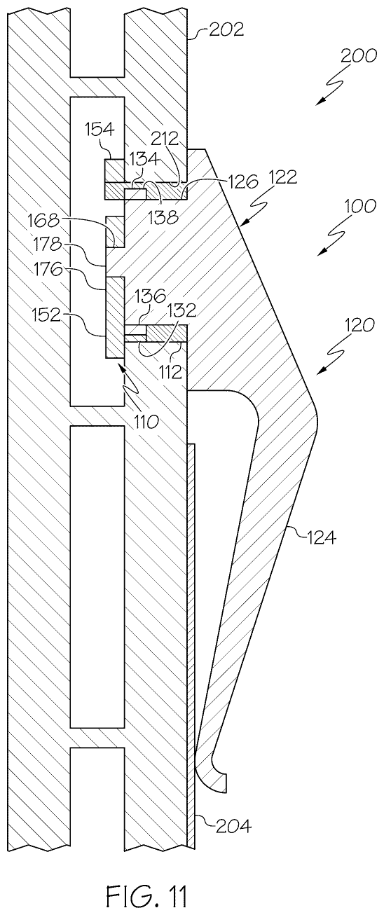

FIGS. 10-12 illustrate examples of the assembly 200 in which a first article 202 and a second article 204 are coupled together using the twist-lock fastener 100. In the illustrative examples, the first article 202 includes or takes the form of a first panel 206 and the second article 204 includes or takes the form of a second panel 208. The anchor 110 is coupled to the second article 204. The retainer 120 is coupled to the anchor 110. The second article 204 is coupled to the retainer 120 or is coupled (e.g., secured or held) to the first article 202 using the retainer 120. In other examples, the first article 202 and/or the second article 204 can include any one of various other structures or components to be coupled together using the twist-lock fastener 100.

As will be described in more detail herein, implementations of the twist-lock fastener 100 utilize a hole 212 that is formed or created in a surface of the first article 202, such as the first panel 206 or other suitable panel structure. In various examples, the anchor 110 is pinched to compress it without plastic deformation. While compressed, the anchor 110 is inserted within the hole 212 and is then released to expand once in place in the hole 212 to provide secure attachment to the article. In various examples, the anchor 110 includes one or more anchor tabs (e.g., first anchor tab 152 and second anchor tab 154) that are used for indexing the anchor 110 within the hole 212 and for providing resistance to rotation of the anchor 110 relative to the article. In various examples, the anchor tabs are serrated (e.g., first teeth 164 and second teeth 166). The retainer 120 utilizes a quarter turn locking interface with the anchor 110 that provides an audible indication (e.g., snap) when the twist-lock fastener 100 is in place and installed properly to indicate to a mechanic that the retainer 120 has been fully secured to the anchor 110. In various examples, a centering pin 178 is provided for alignment during attachment of the retainer 120 and the anchor 110 and during quarter turn rotation of the retainer 120 relative to the anchor 110.

Generally, the twist-lock fastener 100 is a fastener system that can be attached via purely mechanical means with emphasis on design and producing no aesthetic defects to appear on an opposing surface once installed. In various examples, the twist-lock fastener 100 is intended for use with honeycomb style panels to attach other components without adhesives. However, the utility and usefulness of the twist-lock fastener 100 may extend to mounting on the surface of various other types of articles with minimal design changes. Generally, the twist-lock fastener 100 is a two-part system that includes an anchor 110 and a retainer 120. In various examples, the anchor 110 serves as a panel insert and provides an attachment point that can be adapted to a variety of styles of clips or fixtures to fit the design intent for the assembled articles or components.

Examples of the twist-lock fastener 100 and method 1000 beneficially provide a connection point without the need for adhesives or full penetration through a panel structure. Examples of the twist-lock fastener 100 and method 1000 beneficially enable installation on thin panels with minimal appearance to the decorative finish on the opposite side of the panel. Examples of the twist-lock fastener 100 and method 1000 beneficially enable the anchor 110 to take advantage of its shape and the ductility of its material to flex and be inserted into the body of the panel. Examples of the twist-lock fastener 100 and method 1000 beneficially provide a connecting interface that locks the retainer 120 (e.g., a clip or other retaining attachment) in place to prevent the retainer 120 from being removed. In various examples, the twist-lock fastener 100 is configured for use with honey-comb style panel of various thicknesses. The anchor 110 (e.g., panel insert) can have any suitable dimensions or geometry and can be scaled up or down depending on the application requirements.

Referring now to FIGS. 1 and 3-12, the following are examples of the twist-lock fastener 100, according to the present disclosure. The twist-lock fastener 100 includes a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

Referring to FIG. 1, as will be described in more detail herein, in various examples, the twist-lock fastener 100 includes a number of components, including one or more of the anchor 110, the retainer 120, a body 112, a wall 116, a cavity 114, an opening 118, a first slot 132, a second slot 134, a first stop 182, a second stop 184, a first anchor tab 152, first teeth 164, second teeth 166, a lip 162, a receiver 176, an aperture 168, a locking portion 122, a holding portion 124, a base 126, a first retainer flange 136, a second retainer flange 138, a pin 178, a clip 186, an eyelet 188, a magnet 192, a cable holder 194, and a threaded insert 196.

Referring to FIGS. 1 and 3-12, in one or more examples, the anchor 110 is configured for attaching to a first article 202. The anchor 110 includes the body 112. The body 112 forms or defines the cavity 114. The retainer 120 includes the locking portion 122 and the holding portion 124. The locking portion 122 is configured for inserting in the cavity 114 and selectively locking to the body 112. The holding portion 124 extends from the locking portion 122 and is configured for holding a second article 204.

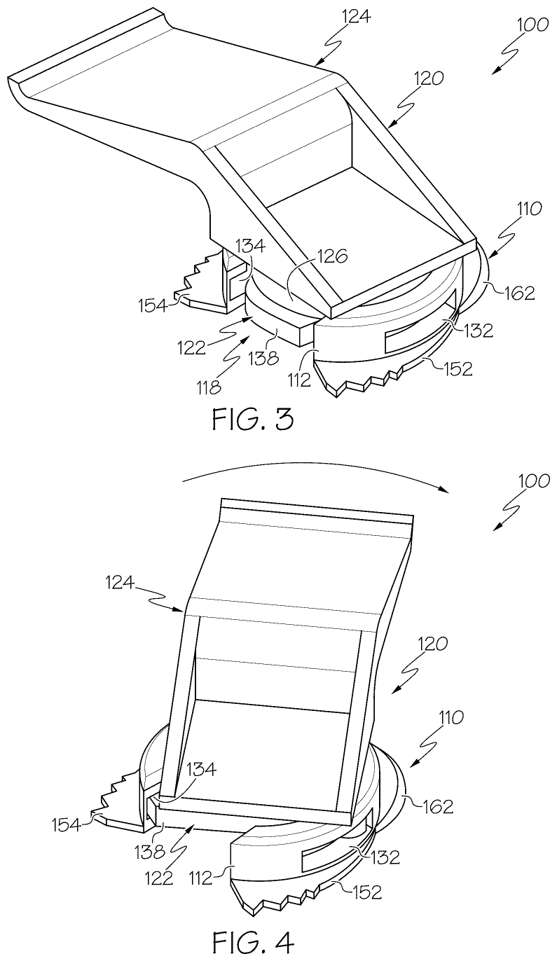

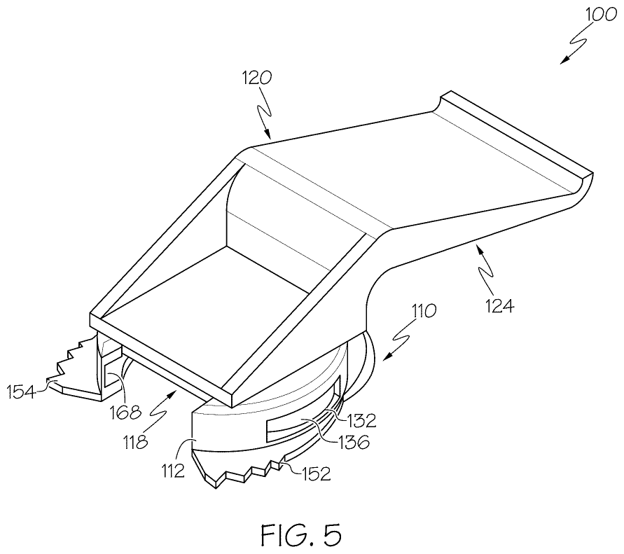

FIGS. 3-5 illustrate examples of the twist-lock fastener 100 at different stages of the connection operation. FIG. 3 illustrates the retainer 120 in an unlocked position or having a first angular orientation relative to the anchor 110 for initially aligning, inserting, and mating the retainer 120 and the anchor 110. FIG. 4 illustrates the rotation of the retainer 120 relative to the anchor 110 from the first angular orientation and unlocked position to a second angular orientation and locked position. FIG. 5 illustrates the retainer 120 in the locked position or having the second angular orientation relative to the anchor 110 for engaging and locking the retainer 120 and the anchor 110 together.

In one or more examples, the locking portion 122 is configured for inserting into the cavity 114 at the first angular orientation (e.g., shown in FIG. 3) and is configured for locking to the body 112 at the second angular orientation (e.g., shown in FIG. 5). In one or more examples, with the locking portion 122 of the retainer 120 inserted in the cavity 114 of the body 112 of the anchor 110, the retainer 120 is configured for rotating (e.g., shown in FIG. 4) relative to the anchor 110 between the unlocked position (e.g., shown in FIG. 3) and the locked position (e.g., shown in FIG. 5).

Referring to FIGS. 1 and 3-9, in one or more examples, the body 112 of the anchor 110 includes of formed the opening 118. The locking portion 122 of the retainer 120 includes the base 126. The base 126 is configured for inserting in the opening 118 in the first angular orientation (e.g., as shown in FIG. 3). The base 126 is configured for engaging the body 112 in the second angular orientation (e.g., as shown in FIG. 5).

Referring to FIGS. 1 and 3-9, in one or more examples, the body 112 of the anchor 110 includes the first slot 132 and the second slot 134. The base 126 of the retainer 120 includes the first retainer flange 136 and the second retainer flange 138. With the retainer 120 in the first angular orientation, the first retainer flange 136 and the first slot 132 are configured for mating together. With the retainer 120 in the second angular orientation, the second retainer flange 138 and the second slot 134 are configured for mating together.

Referring to FIGS. 1, 3-5 and 9, in one or more examples, the first slot 132 includes a first end 142 and a second end 144. The second slot 134 includes a first end 146 and the second end 148. The second end 144 of first slot 132 and the second end 148 of second slot 134 are closed or otherwise configured for stopping rotation of the retainer 120 at the second angular orientation. As an example, the second end 144 of first slot 132 forms or serves as the first stop 182 upon which the first retainer flange 136 contacts when the retainer 120 is fully rotated to the second angular orientation and, thus, the locked position. Similarly, the second end 148 of second slot 134 forms or serves as the second stop 184 upon which the second retainer flange 138 contacts when the retainer 120 is fully rotated to the second angular orientation and, thus, the locked position. The first end 146 of second slot 134 is open or otherwise configured for receiving the second retainer flange 138 when rotating the retainer 120 relative to the anchor 110 from the first angular orientation to the second angular orientation.

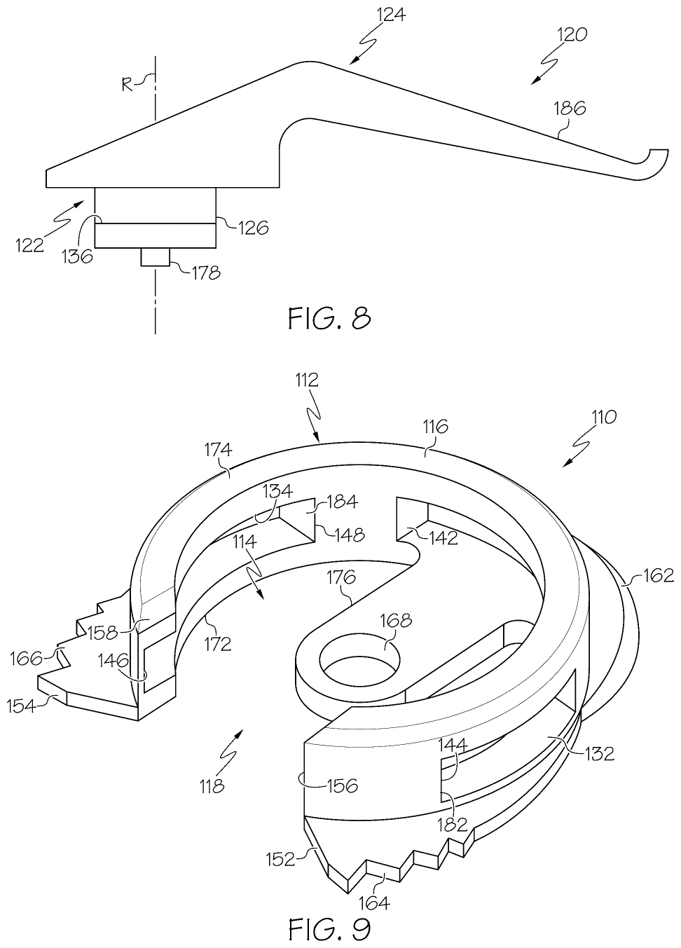

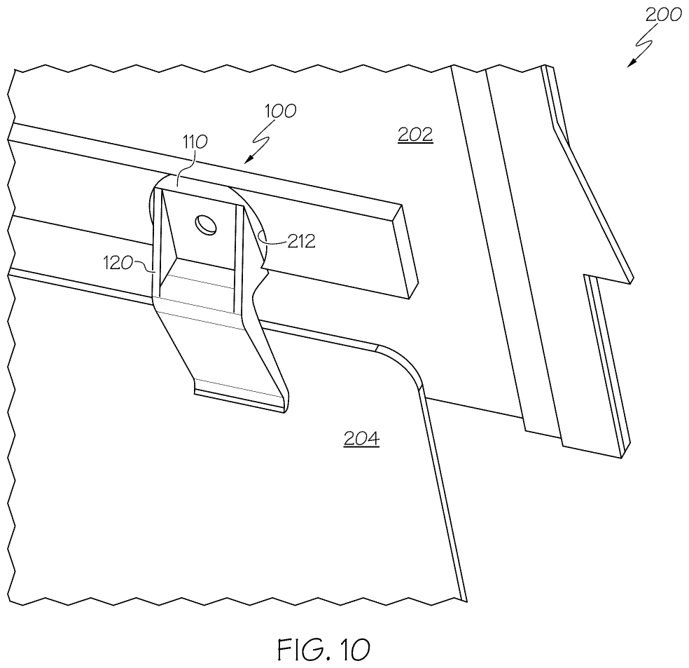

Referring to FIGS. 1 and 9, in one or more examples, the body 112 of the anchor 110 has a semi-cylindrical shape to form a cylindrical shape of the cavity 114. In one or more examples, the body 112 includes or is formed by a semi-cylindrical wall 116. In these examples, the body 112 includes a first longitudinal end 172 and a second longitudinal end 174 that is opposite the first longitudinal end 172 to form the cavity 114 having the cylindrical shape. The body 112 includes a first arc end 156 and a second arc end 158 that is spaced away from the first arc end 156 to form the opening 118.

In one or mor examples, the body 112, such as the semi-cylindrical wall 116 having the opening 118, is configured for flexing in response to an applied force to reduce a cross-sectional dimension (e.g., diameter) of the anchor 110. In these examples, the body 112 can be squeezed by a user to push the first arc end 156 and the second arc end 158 together and, thereby, reducing the diameter of the anchor 110 for insertion within the hole 212 of the first article 202.

Referring to FIGS. 1, 3-5 and 9, in one or more examples, the anchor 110 includes the first anchor tab 152. The first anchor tab 152 extends outwardly (e.g., radially outward) from the body 112. In one or more examples, the first anchor tab 152 is located along the first longitudinal end 172. In one or more examples the first anchor tab 152 is located proximate the first arc end 156. In one or more examples, the first anchor tab 152 is located adjacent to the opening 118. The anchor 110 includes the second anchor tab 154. The second anchor tab 154 extends outwardly (e.g., radially outward) from the body 112. In one or more examples, the second anchor tab 154 is located along the second longitudinal end 174. In one or more examples, the second anchor tab 154 is located proximate the second arc end 158. In one or more examples, the second anchor tab 154 is located adjacent to the opening 118, opposite or spaced away from the first anchor tab 152. In these examples, the first anchor tab 152 and the second anchor tab 154 are configured for indexing the anchor 110 within the hole 212 and for providing resistance to rotation of the anchor 110 relative to the first article 202.

Referring to FIGS. 1, 3-5 and 9, in one or more examples, the anchor 110 includes the lip 162. The lip 162 extends outwardly (e.g., radially outward) from the body 112. In one or more examples, the lip 162 is located opposite the opening 118. In one or more examples, the lip 162 has a semi-circular shape. In these examples, the lip 162 is configured for indexing the anchor 110 within the hole 212 and for providing resistance to rotation of the anchor 110 relative to the first article 202.

Referring to FIGS. 1, 3-5 and 9, in one or more examples, the anchor 110 includes the first teeth 164. In one or more examples, the first teeth 164 extend outwardly from and along an edge of the first anchor tab 152. In one or more examples, the first teeth 164 extend along at least a portion of an edge of the first anchor tab 152. In one or more examples, the anchor 110 includes the second teeth 166. In one or more examples, the second teeth 166 extend outward from the second anchor tab 154. In one or more examples, the second teeth 166 extend along at least a portion of an edge of the second anchor tab 154. In these examples, the first teeth 164 and the second teeth 166 form serrations configured for engaging a surface of the hole 212 in the first article 202 following insertion of the anchor 110.

Referring to FIGS. 1, 8 and 9, in one or more examples, the anchor 110 includes the receiver 176. The receiver 176 extends inwardly (e.g., radially inward) from the body 112. In one or more examples, the receiver 176 is opposite the opening 118. The receiver 176 includes or forms the aperture 168. The retainer 120 includes the pin 178. The pin 178 extends outwardly from the base 126. The pin 178 is configured for inserting in the aperture 168. In one or more examples, with the pin 178 inserted in the aperture 168, the pin 178 extends along or otherwise defines an axis of rotation R about which the retainer 120 is configured to rotate relative to the anchor 110. In one or more examples, insertion of the pin 178 in the aperture 168 provides an audible indication (e.g., snap) when the retainer 120 is properly in place and installed to indicate that the retainer 120 has been properly secured to the anchor 110.

Referring to FIGS. 1, 3-8 and 10-12, in one or more examples, the holding portion 124 includes the clip 186. In these examples, the clip 186 includes or takes the form of a spring clip or spring arm that is configured for securing the second article 204 to the first article 202 by compressing (e.g., pressing and holding) the second article 204 against the second article 204.

Referring to FIG. 1, in other examples, the holding portion 124 can take any other suitable form or include various other mechanisms configured for holding the second article 204. In one or more examples, the holding portion 124 includes the eyelet 188. In one or more examples, the holding portion 124 includes the magnet 192. In one or more examples, the holding portion 124 includes the cable holder 194. In one or more examples, the holding portion 124 includes the threaded insert 196.

Referring to FIGS. 1 and 3-12, in one or more examples, the twist-lock fastener 100 includes the anchor 110. The anchor 110 is configured for attaching to the first article 202. The anchor 110 includes the body 112. The body 112 has a semi-cylindrical shape. The body 112 includes the first longitudinal end 172 and the second longitudinal end 174 opposite the first longitudinal end 172 to form the cavity 114 having a cylindrical shape. The body 112 includes the first arc end 156 and the second arc end 158 spaced away from the first arc end 156 to form the opening 118 in the body 112. The anchor 110 includes the first slot 132 formed in the body 112 between the first longitudinal end 172 and the second longitudinal end 174. The anchor 110 includes the second slot 134 formed in the body 112 between the first longitudinal end 172 and the second longitudinal end 174. The second slot 134 is opposite the first slot 132. The anchor 110 includes the first anchor tab 152 extending outwardly from the body 112 proximate the first arc end 156. The anchor 110 includes the second anchor tab 154 extending outwardly from the body 112 proximate the second arc end 158. The anchor 110 includes the lip 162 extending outwardly from the body 112 opposite the opening 118. The anchor 110 includes the first teeth 164 extending from the first anchor tab 152. The anchor 110 includes the second teeth 166 extending from the second anchor tab 154. The anchor 110 includes the receiver 176 extending inwardly from the body 112 opposite the opening 118 and having the aperture 168. The retainer 120 is configured for mating with the anchor 110 in the first angular orientation and engaging the anchor 110 in the second angular orientation. The retainer 120 includes the locking portion 122 configured for inserting in the cavity 114 and selectively locking to the body 112. The locking portion 122 includes the base 126 configured for inserting in the opening 118 in the first angular orientation and engaging the body 112 in the second angular orientation. The locking portion 122 includes the first retainer flange 136 extending outwardly from the base 126 and configured for mating with the first slot 132. The locking portion 122 includes the second retainer flange 138 extending outwardly from the base 126 opposite the first retainer flange 136 and configured for mating with the second slot 134. The locking portion 122 includes the pin 178 extending from the base 126 and configured for inserting in the aperture 168 of the receiver 176. The retainer 120 includes the holding portion 124 extending from the locking portion 122 and configured for holding the second article 204. With the locking portion 122 of the retainer 120 inserted in the cavity 114 of the body 112 of the anchor 110, the retainer 120 is configured for rotating relative to the anchor 110 between the unlocked position and the locked position.

Referring now to FIGS. 1 and 10-12, the following are examples of the assembly 200, according to the present disclosure. The assembly 200 includes a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

In one or more examples, the assembly 200 includes the first article 202 and the second article 204 coupled to the first article 202 by the twist-lock fastener 100.

In one or more examples, the assembly 200 includes the first article 202. The first article 202 includes the hole 212. The assembly 200 includes the anchor 110, which is situated in the hole 212 and coupled to the first article 202. The anchor 110 includes the body 112 forming the cavity 114. The assembly 200 includes the retainer 120. The retainer 120 includes the locking portion 122. The locking portion 122 is inserted in the cavity 114 and is selectively locked to the body 112. The retainer 120 includes the holding portion 124. The holding portion 124 extends from the locking portion 122. The assembly 200 includes the second article 204. The second article 204 is coupled to the first article 202 by the holding portion 124.

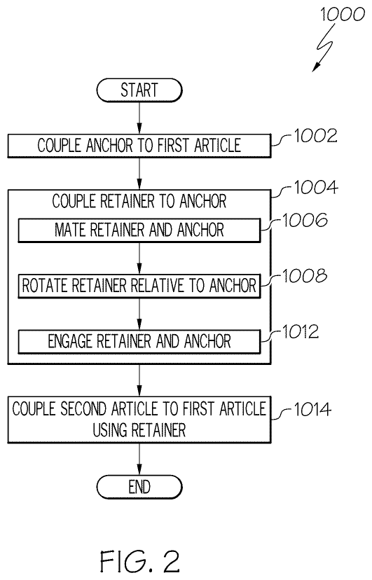

Referring now to FIG. 2, the following are examples of the method 1000, according to the present disclosure. The method 1000 includes a number of elements, steps, operations, or processes. Not all of the elements, steps, operations, or processes described or illustrated in one example are required in that example. Some or all of the elements, steps, operations, or processes described or illustrated in one example can be combined with other examples in various ways without the need to include other elements, steps, operations, or processes described in those other examples, even though such combination or combinations are not explicitly described or illustrated by example herein.

Referring generally to FIGS. 1 and 3-12 and particularly to FIG. 2, in one or more examples, the method 1000 is implemented using the twist-lock fastener 100 (FIG. 1). In one or more examples, the method 1000 is for forming the assembly 200 by fastening the first article 202 and the second article 204 together using the twist-lock fastener 100.

In one or more examples, the method 1000 includes a step of coupling 1002 the anchor 110 of the twist-lock fastener 100 to the first article 202. The method 1000 includes a step of coupling 1004 the retainer 120 of the twist-lock fastener 100 and the anchor 110 by: in a first angular orientation, mating 1006 the retainer 120 with the anchor 110; rotating 1008 the retainer 120 relative to the anchor 110 from the first angular orientation to the second angular orientation; and, in the second angular orientation, engaging 1012 the retainer 120 to the anchor 110. The method 1000 includes a step of coupling 1014 the second article 204 to the first article 202 using the retainer 120.

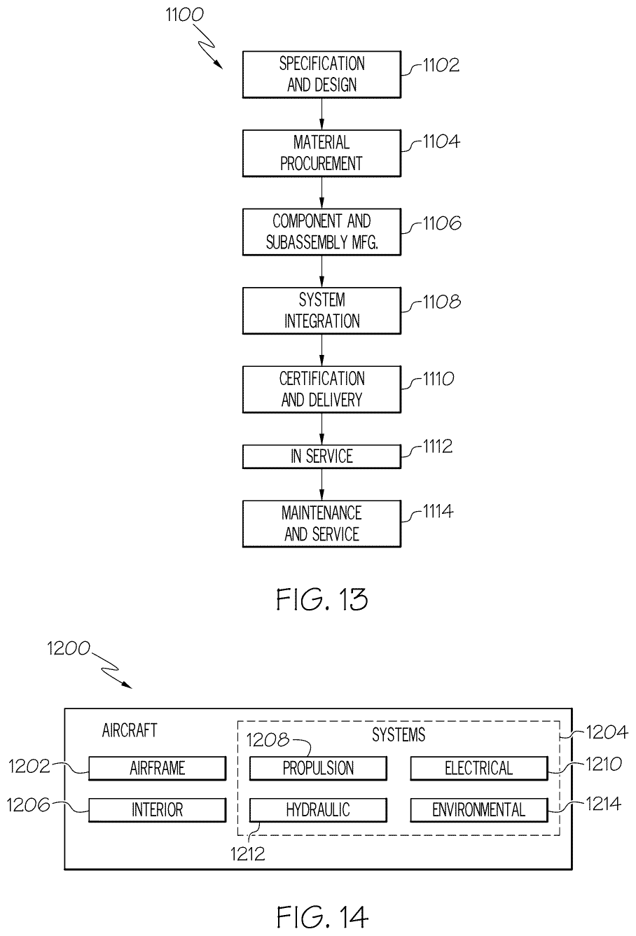

Referring now to FIGS. 10 and 11, examples of the twist-lock fastener 100, the assembly 200, and the method 1000 described herein, may be related to, or used in the context of, the aerospace manufacturing and service method 1100, as shown in the flow diagram of FIG. 13 and an aircraft 1200, as schematically illustrated in FIG. 14. As an example, the aircraft 1200 and/or the manufacturing and service method 1100 may include or utilize articles or components that are coupled or otherwise secured together using examples of the twist-lock fastener 100 and/or according to examples of the method 1000.

Referring to FIG. 14, which illustrates an example of the aircraft 1200. The aircraft 1200 can be any aerospace vehicle or platform. In one or more examples, the aircraft 1200 includes the airframe 1202 having the interior 1206. The aircraft 1200 includes a plurality of onboard systems 1204 (e.g., high-level systems). Examples of the onboard systems 1204 of the aircraft 1200 include propulsion systems 1208, hydraulic systems 1212, electrical systems 1210, and environmental systems 1214. In other examples, the onboard systems 1204 also includes one or more control systems coupled to the airframe 1202 of the aircraft 1200. In yet other examples, the onboard systems 1204 also include one or more other systems, such as, but not limited to, communications systems, avionics systems, software distribution systems, network communications systems, passenger information/entertainment systems, guidance systems, radar systems, weapons systems, and the like. The aircraft 1200 can have any number of articles or components (e.g., assembly 200) that are coupled or otherwise secured together using examples of the twist-lock fastener 100 and/or according to examples of the method 1000.

Referring to FIG. 13, during pre-production of the aircraft 1200, the manufacturing and service method 1100 includes specification and design 1102 of the aircraft 1200 and material procurement 1104. During production of the aircraft 1200, component and subassembly manufacturing 1106 and system integration 1108 of the aircraft 1200 take place. Thereafter, the aircraft 1200 goes through certification and delivery 1110 to be placed in service 1112. Routine maintenance and service 1114 includes modification, reconfiguration, refurbishment, etc. of one or more systems of the aircraft 1200.

Each of the processes of the manufacturing and service method 1100 illustrated in FIG. 13 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

Examples of the twist-lock fastener 100, the assembly 200, and the method 1000, shown and described herein, may be employed during any one or more of the stages of the manufacturing and service method 1100 shown in the flow diagram illustrated by FIG. 13. In an example, physical connection of various articles or components of the aircraft 1200 can be achieved using the twist-lock fastener 100 and/or according to the method 1000 during a portion of component and subassembly manufacturing 1106 and/or system integration 1108. Further, physical connection of various articles or components of the aircraft 1200 can be achieved using the twist-lock fastener 100 and/or according to the method 1000 while the aircraft 1200 is in service 1112. Also, physical connection of various articles or components of the aircraft 1200 can be achieved using the twist-lock fastener 100 and/or according to the method 1000 during system integration 1108 and certification and delivery 1110. Similarly physical connection of various articles or components of the aircraft 1200 can be achieved using the twist-lock fastener 100 and/or according to the method 1000 while the aircraft 1200 is in service 1112 and during maintenance and service 1114.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1, 3-12 and 14, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1, 3-12 and 14, referred to above, need be included in every example and not all elements, features, and/or components described herein are necessarily depicted in each illustrative example. Accordingly, some of the elements, features, and/or components described and illustrated in FIGS. 1, 3-12 and 14 may be combined in various ways without the need to include other features described and illustrated in FIGS. 1, 3-12 and 14, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1, 3-12 and 14, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1, 3-12 and 14, and such elements, features, and/or components may not be discussed in detail herein with reference to each of FIGS. 1, 3-12 and 14. Similarly, all elements, features, and/or components may not be labeled in each of FIGS. 1, 3-12 and 14, but reference numerals associated therewith may be utilized herein for consistency.

In FIGS. 2 and 13, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 2 and 13 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need to be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the twist-lock fastener 100, the assembly 200, and the method 1000 have been shown and described, modifications may occur to those skilled in the art upon reading the specification. The present application includes such modifications and is limited only by the scope of the claims.

What is claimed is:

1. A twist-lock fastener comprising:
an anchor configured for attaching to a first article and comprising a body forming a cavity; and
a retainer comprising:
a locking portion configured for inserting in the cavity and selectively locking to the body; and
a holding portion extending from the locking portion and configured for holding a second article.

2. The twist-lock fastener of claim 1, wherein, with the locking portion of the retainer inserted in the cavity of the body of the anchor, the retainer is configured for rotating relative to the anchor between an unlocked position and a locked position.

3. The twist-lock fastener of claim 1, wherein:
the body of the anchor comprises an opening; and
the locking portion of the retainer comprises a base configured for inserting in the opening in a first angular orientation and engaging the body in a second angular orientation.

4. The twist-lock fastener of claim 3, wherein
the body of the anchor comprises a first slot and a second slot;
the base of the retainer comprises a first retainer flange and a second retainer flange;
with the retainer in the first angular orientation, the first retainer flange and the first slot are configured for mating together; and
with the retainer in the second angular orientation, the second retainer flange and the second slot are configured for mating together.

5. The twist-lock fastener of claim 4, wherein:
the first slot comprises a first end and a second end;
the second slot comprises a first end and the second end;
the second end of first slot and the second end of second slot are configured for stopping rotation of the retainer at the second angular orientation; and
the first end of second slot is configured for receiving the second retainer flange when rotating the retainer relative to the anchor from the first angular orientation to the second angular orientation.

6. The twist-lock fastener of claim 3, wherein:
the body of the anchor has a semi-cylindrical shape to form a cylindrical shape of the cavity; and
the body comprises a first arc end and a second arc end spaced away from the first arc end to form the opening.

7. The twist-lock fastener of claim 6, wherein the body is configured for flexing in response to an applied force to reduce a cross-sectional dimension of the anchor.

8. The twist-lock fastener of claim 6, wherein the anchor further comprises:
a first anchor tab extending outwardly from the body proximate the first arc end; and
a second anchor tab extending outwardly from the body proximate the second arc end.

9. The twist-lock fastener of claim 8, wherein the anchor further comprises a lip extending outwardly from the body opposite the opening.

10. The twist-lock fastener of claim 8, wherein the anchor further comprises:
first teeth extending from the first anchor tab; and
second teeth extending from the second anchor tab.

11. The twist-lock fastener of claim 3, wherein:
the anchor further comprises a receiver extending inwardly from the body opposite the opening;
the receiver comprises an aperture; and
the retainer comprises a pin extending from the base and configured for inserting in the aperture.

12. The twist-lock fastener of claim 1, wherein the holding portion comprises a clip.

13. The twist-lock fastener of claim 1, wherein the holding portion comprises an eyelet.

14. The twist-lock fastener of claim 1, wherein the holding portion comprises a magnet.

15. The twist-lock fastener of claim 1, wherein the holding portion comprises a cable holder.

16. The twist-lock fastener of claim 1, wherein the holding portion comprises a threaded insert.

17. The twist-lock fastener of claim 1, wherein:
the body has a semi-cylindrical shape and comprises:
a first longitudinal end and a second longitudinal end opposite the first longitudinal end to form a cavity having a cylindrical shape;
a first arc end and a second arc end spaced away from the first arc end to form an opening in the body;
a first slot formed in the body proximate the first longitudinal end;
a second slot formed in the body proximate the first longitudinal end and opposite the first slot;
a first anchor tab extending outwardly from the body proximate the first arc end;
a second anchor tab extending outwardly from the body proximate the second arc end;
a lip extending outwardly from the body opposite the opening;
first teeth extending from the first anchor tab;
second teeth extending from the second anchor tab; and
a receiver extending inwardly from the body opposite the opening and having an aperture;
the retainer is configured for mating with the anchor in a first angular orientation and engaging the anchor in a second angular orientation;
the locking portion comprises:
a base configured for inserting in the opening in the first angular orientation and engaging the body in the second angular orientation;
a first retainer flange extending outwardly from the base and configured for mating with the first slot;
a second retainer flange extending outwardly from the base opposite the first retainer flange and configured for mating with the second slot; and
a pin extending from the base and configured for inserting in the aperture of the receiver; and
a holding portion extending from the locking portion and configured for holding a second article,
the body is configured for flexing in response to an applied force to reduce a cross-sectional dimension of the anchor; and
with the locking portion of the retainer inserted in the cavity of the body of the anchor, the retainer is configured for rotating relative to the anchor between an unlocked position and a locked position.

18. An assembly comprising:
a first article comprising a hole;
an anchor situated in the hole and coupled to the first article, the anchor comprising a body forming a cavity;
a retainer comprising:
a locking portion inserted in the cavity and selectively locked to the body; and
a holding portion extending from the locking portion; and
a second article coupled to the first article by the holding portion.

19. The assembly of claim 18, wherein:
the body is configured for flexing in response to an applied force to reduce a cross-sectional dimension of the anchor for fitting a portion of the anchor within the hole; and
with the locking portion of the retainer inserted in the cavity of the body of the anchor, the retainer is configured for rotating relative to the anchor between an unlocked position and a locked position.

20. A method for fastening, the method comprising:
coupling an anchor of a twist-lock fastener to a first article;
coupling a retainer of the twist-lock fastener and the anchor by:
in a first angular orientation, mating the retainer with the anchor;
rotating the retainer relative to the anchor from the first angular orientation to a second angular orientation; and
in the second angular orientation, engaging the retainer to the anchor; and
coupling a second article to the first article using the retainer.
